(19) United States
(12) Patent Application Publication
(10) Pub. No.: US 2009/0125799 A1
(43) Pub. Date: May 14, 2009

(54) User interface image partitioning

(76) Inventor: Nathaniel B. Kirby, Wheeling, IL (US)

Correspondence Address: PATTI, HEWITT & AREZINA LLC, ONE NORTH LASALLE STREET, 44TH FLOOR, CHICAGO, IL, 60602, US

(21) Appl. No.: 11/985,133

(22) Filed: Nov. 14, 2007

(51) Int. Cl. G06F 3/048

(52) U.S. Cl. 715/234

(57) ABSTRACT

A user interface image for an application is partitioned into a plurality of sub-images that correspond to a plurality of tiles of a local display grid. At least one sub-image of the plurality of sub-images is sent to a client component as at least one web page element with an absolute position for a remote display of the user interface image by a web browser of the client component, wherein the at least one web page element corresponds to at least one tile of the plurality of tiles of the local display grid.

### TECHNICAL FIELD

The invention relates generally to user interfaces and more particularly to remote display of a user interface.

### BACKGROUND

Computer applications are ubiquitous in many areas of business, education, and home use. The applications typically provide a graphical user interface to a user for interaction with the application to provide a desired feature. An application is typically purchased and installed on a single computer. The application must then be executed on that computer and is not available elsewhere. In some areas of business or education, installation of an application over a large number of computers is a labor-intensive task. For example, a school with hundreds of computers in many classrooms would need one copy of an application installed on each computer. Web-based applications can provide some basic functionality without the requirement of installing the application on each computer. However, providing the functionality of a specialized application through a web interface remains a challenge.

### SUMMARY

The invention in one implementation encompasses a method. A user interface image for an application is partitioned into a plurality of sub-images that correspond to a plurality of tiles of a local display grid. At least one sub-image of the plurality of sub-images is sent to a client component as at least one web page element with an absolute position for a remote display of the user interface image by a web browser of the client component, wherein the at least one web page element corresponds to at least one tile of the plurality of tiles of the local display grid.

Another implementation of the invention encompasses a method. A user interface image is generated for a music composition application requested by a user of a web client. The user interface image is sent to the web client. An asynchronous hypertext transfer protocol (HTTP) connection is established with the web client. A user input from the web client is received through the asynchronous HTTP connection. The user interface image is updated based on the user input. An updated portion of the user interface image is sent to the web client through the asynchronous HTTP connection.

A further implementation of the invention encompasses an apparatus. The apparatus comprises a server component that comprises an audio processor. The server component is configured to provide a web page to a client component and to receive audio note placement information from the client component. The server component is configured to employ the audio processor to convert the audio note placement information into an audio track.

### DESCRIPTION OF THE DRAWINGS

Features of example implementations of the invention will become apparent from the description, the claims, and the accompanying drawings in which:

FIG. 1 is a representation of one implementation of an apparatus that comprises a server component and a client component.

FIG. 2 is a representation of a graphical user interface for the client component of the apparatus of FIG. 1.

FIG. 3 is a representation of a message flow for the apparatus of FIG. 1.

FIG. 4 is a representation of a graphical user interface for the client component of the apparatus of FIG. 1 and further illustrates a musical notation application.

FIGS. 5-7 are a sequence of representations of the graphical user interface of FIG. 4 that further illustrate the placement of a musical symbol.

FIG. 8 is a representation of the graphical user interface of FIG. 4 and further illustrates a music notation with lyrics.

FIG. 9 is a representation of a simplified graphical user interface for a musical notation application.

### DETAILED DESCRIPTION

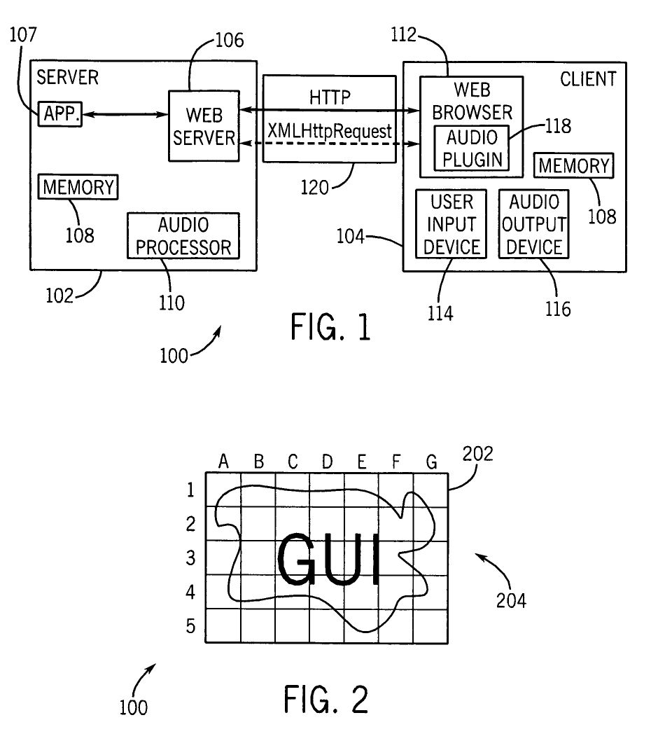

Turning to FIG. 1, an apparatus 100 in one example comprises a server component 102 and a client component 104. The server component 102 in one example comprises a computer, server, computer cluster, or other processing device. The server component 102 in one example comprises a web server 106, an application 107, and an instance of a memory unit 108. In a further example, the server component 102 comprises an audio processor 110. The web server 106 in one example is configured to receive requests for information and transmit information through employment of the hypertext transfer protocol (HTTP).

The web server 106 in one example is implemented by software that is executed on a computer, for example, Apache (Apache Software Foundation; Forest Hill, Md.) or Internet Information Server (“IIS”; Microsoft Corporation; Redmond, Wash.). The audio processor 110 in one example is configured to output an encoded audio stream or file. For example, the audio processor 110 employs a codec for generation of the encoded audio stream, such as an MP3 codec, Windows Media Audio codec, Vorbis codec, etc. The audio processor 110 may be a dedicated processor (e.g., CPU), or a software program or module that is executed on another processor, as will be understood by those skilled in the art.

The web server 106 in one example works in cooperation with one or more additional software components, such as a web application framework and/or database. Examples of web application frameworks are Ruby on Rails (created by David Heinemeier Hansson; http://www.rubyonrails.org/), ASP.NET (Microsoft Corporation; Redmond, Wash.), Java and J2EE (Sun Microsystems, Inc.; Santa Clara, Calif.), PHP (“PHP: Hypertext Preprocessor”, www.php.net), and Django (www.djangoproject.com).

The client component 104 in one example comprises a computer, personal digital assistant, or other user device. The client component 104 in one example comprises a web browser 112 and a user input device 114. In a further example, the client component 104 comprises an instance of the memory unit 108. The web browser 112 comprises a graphical user interface for display of a web page or other hypertext markup language (HTML) content. In a further example, the web browser 112 comprises an audio plug-in 118. The audio plug-in 118 in one example comprises an audio codec for decoding the encoded audio stream or file generated by the audio processor 110. The audio plug-in 118 in one example is built into the web browser 112, for example, the web browser 112 inherently provides the functionality of the audio plug-in 118 in a common (e.g., default) configuration. In this implementation, an end user of the client component 104 does not need to manually configure the client component 104 to play back the encoded audio stream, as will be appreciated by those skilled in the art. As is known in the art, many personal computers are preconfigured to process and display web pages (e.g., HTML pages) and also to play audio files. Examples of the web browser 112 comprise Internet Explorer, Mozilla Firefox, Opera, Safari, and Netscape. Alternative examples of the web browser 112 may be implemented as an application for use on a PDA or mobile phone, for example, an embedded application or plug-in.

The user input device 114 may be any one or more of a keyboard, mouse, trackball, or other input device. In a further example, the user input device 114 may comprise a musical instrument communicatively coupled with the client component 104, such as an electronic piano or keyboard coupled through a MIDI port. In another example, the user input device 114 comprises a microphone or other input device capable of receiving audio inputs, for example, notes played by a musical instrument. The client component 104 in one example comprises an audio output device 116, such as a speaker or headphones. The audio output device 116 in one example receives an audio output from the audio plug-in 118, as will be appreciated by those skilled in the art.

Various components of the client component 104 may be integrated or separate from each other. For example, the audio output device 116 may further comprise an audio card for a personal computer that outputs a signal to an external amplifier, which then powers a speaker. The user input device 114 may be integral with the client component 104 or a separate component. One or more signal processing units (not shown), such as audio processors, may communicatively couple the user input device 114 to the client component 104.

The server component 102 and the client component 104 are communicatively coupled by a network 120. The network 120 may comprise wireline communication components, optical communication components, wireless communication components, and combinations thereof. The network 120 in one example supports transmission control protocol/internet protocol (TCP/IP) for communication between the server component 102 and the client component 104. The network 120 may support other communication protocols, as will be understood by those skilled in the art. In one example, the network 120 comprises the Internet, a private intranet, or a local area network (LAN).

The server component 102 in one example is configured to provide the application 107 to a user of the client component 104. For example, the user employs the client component 104, through the web browser 112, to access the application 107 from the server component 102. The user may interact with the application 107 through the user input device 114 of the client component 104 and the graphical user interface of the web browser 112, as will be appreciated by those skilled in the art. Examples of the application 107 that the user may access comprise remote desktop applications, computer aided design (CAD) applications, music notation applications, and other client applications that may typically be executed on a computer or handheld device. In this implementation, the application 107 is executed by the server component 102, which generates a user interface for the application 107. The user interface is provided to the web browser 112 of the client component 104 for the user, as described herein. In other implementations, the application 107 may be designed as a client/server application.

In one implementation, the server component 102 is configured to generate the user interface for the application 107 as a user interface image. For example, the user interface image may comprise a bitmap of a display screen that the application 107 is designed to be displayed upon. In a further example, the user interface image may comprise an alternative image format, such as JPEG, GIF, TIFF, SVG or other compressed or uncompressed image formats. Turning to FIG. 2, the server component 102 in one example is configured to create a local display grid 202 to partition a user interface image 204 into a plurality of sub-images. The local display grid 202 in one example comprises a plurality of tiles, for example, tiles A1-G5. Accordingly, the user interface image 204 in this example is subdivided into thirty-five sub-images that correspond to the plurality of tiles A1-G5. The local display grid 202 may be implemented as a two-dimensional array, table, or other data structure.

The server component 102 in one example sends the user interface image to the web browser 112 as a web page for a remote display of the user interface image 204. For example, the server component 102 creates a web page that comprises the user interface image for display by the web browser 112. The web page in one example comprises a plurality of web page elements that correspond to the plurality of tiles. The web page elements in one example comprise an absolute position, for example, the web page element comprises a DIV web page element.

The user of the client component 104 in one example interacts with the user interface image 204 displayed by the web browser 112. The web browser 112 in one example is configured to capture or interpret the user's interaction with the web page and communicate the interaction with the server component 102. The server component 102 in one example employs the interaction to modify or replace a portion of the user interface image 204. For example, the server component 102 modifies the user interface image or a portion thereof based on a user interface change in the application. The server component 102 is configured to identify which portion of the user interface image 204 has been modified and select the corresponding one or more tiles. The server component 102 in one example identifies a modified tile through employment of a hash table that translates coordinates of changes to the user interface image to an index of the modified tile.

The server component 102 sends an updated portion of the user interface image, for example, a modified or new image sub-portion, to the corresponding web page element in the web browser 112. The image sub-portion in one example comprises a tiled image portion. As one example, if the user wishes to remove the “I” from “GUI”, the server component 102 determines that tiles E2, E3, and E4 have been modified. The server component 102 then updates the web page elements in the web browser 112 that correspond to the tiles E2, E3, and E4. As another example, if the user wishes to remove the “G” from “GUI”, the server component updates the web page elements that correspond to the tiles B2, C2, B3, C3, B4, and C4, as will be appreciated by those skilled in the art.

The server 102 in one example employs a dynamic and/or asynchronous communication technique to transfer the interaction and the image sub-portion between the server component 102 and the web browser 112, for example, Asynchronous JavaScript and XML (Ajax). The server component 102 in one example creates the web page to support Ajax communication through an XMLHttpRequest application programming interface (API) between the web browser 112 and the server component 102. The graphical user interface displayed to the user of the client component 104 in one example may be dynamically and efficiently updated by sending only the tiles that have been modified and asynchronously updating the graphical user interface on the web browser 112. The server component 102 employs Ajax to promote “seamless” adjustments to the user interface, as will be appreciated by those skilled in the art.

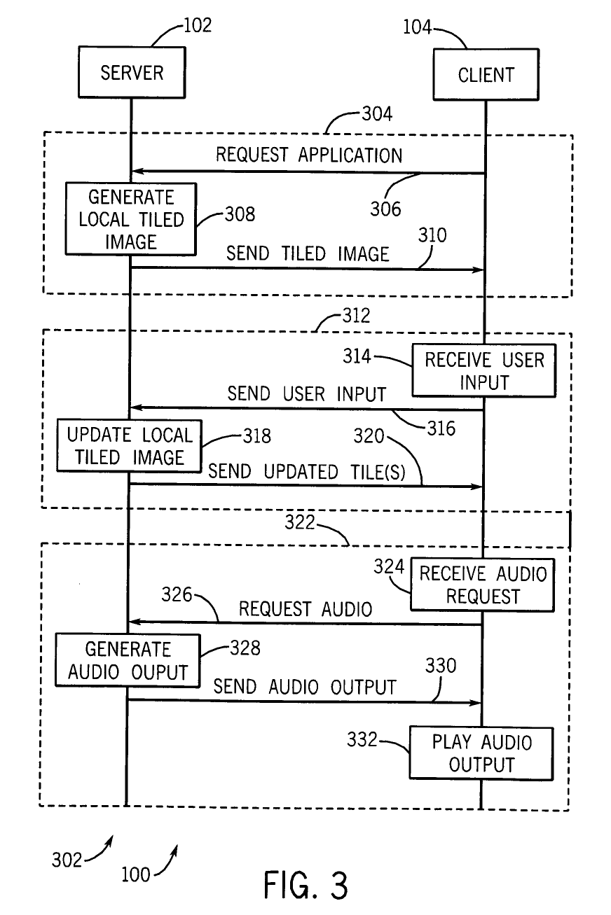

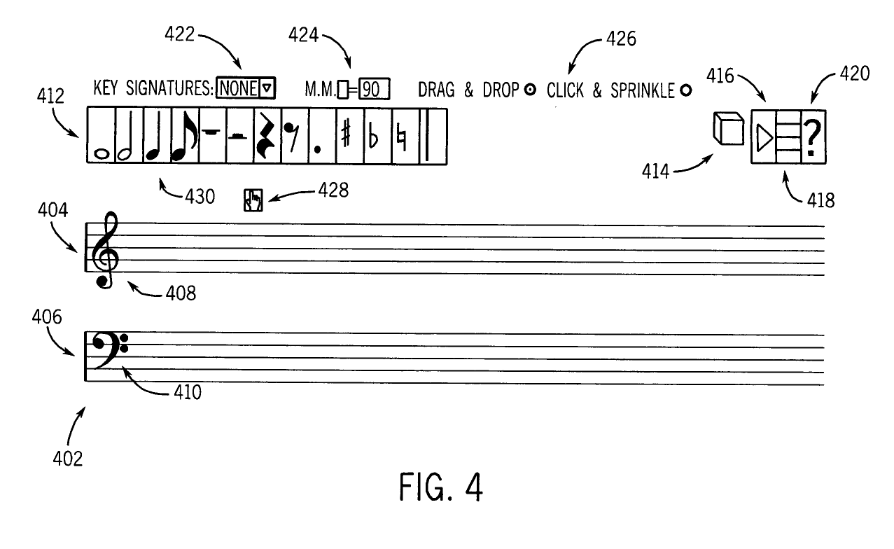

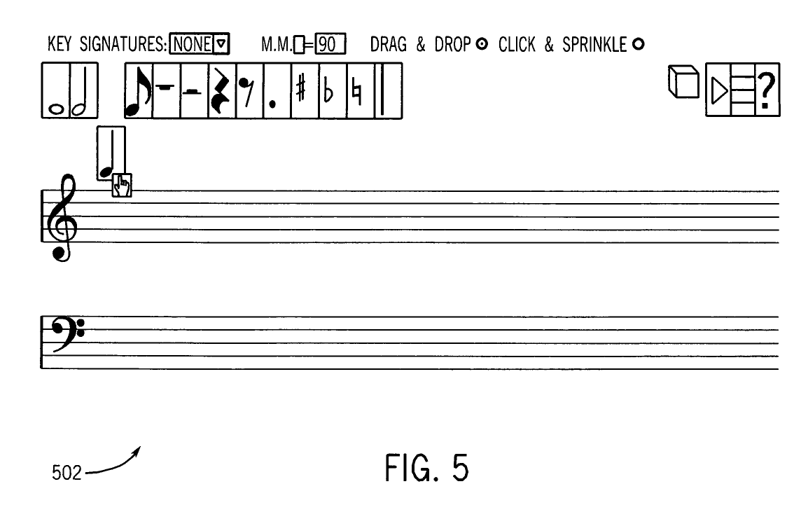

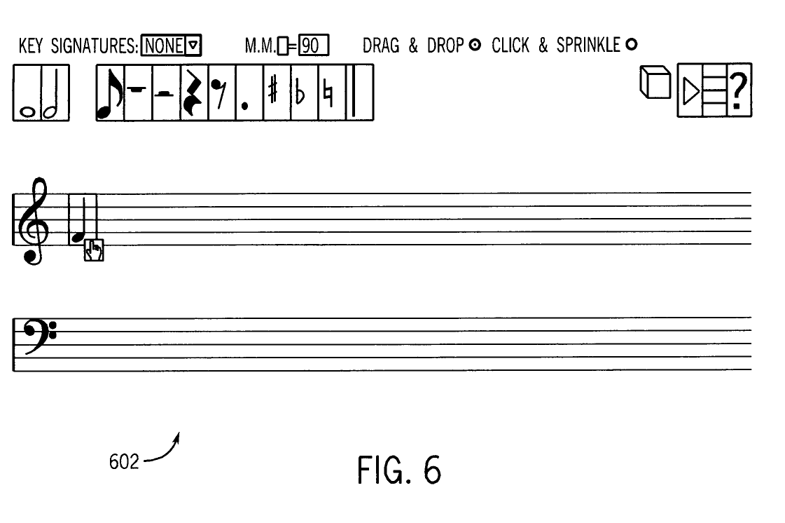

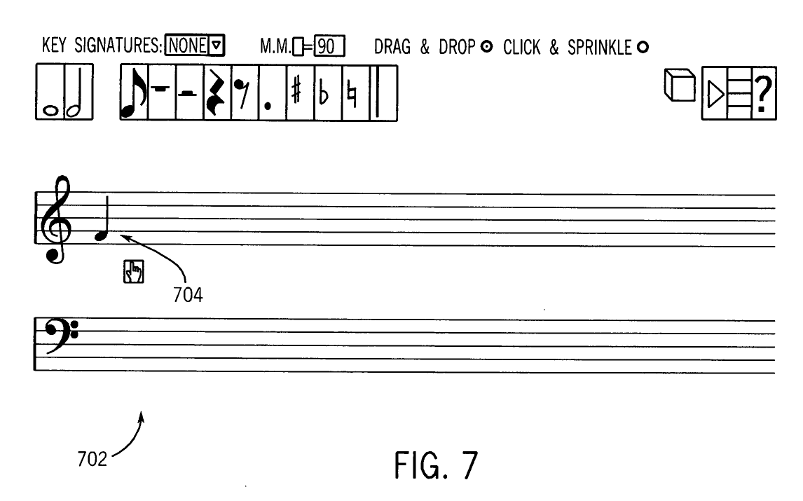

An illustrative description of operation of the apparatus 100 is presented, for explanatory purposes. In one implementation, the application 107 comprises a music notation application. Turning to FIG. 3, logic flow 302 shows one implementation that provides the application 107 to a user of the client component 104. Turning to FIGS. 4-7, graphical user interfaces 402, 502, 602, and 702 show examples of a progression of user interface images for the music notation application that are displayed to the user of the client component 104.

Referring to FIG. 3, the user of the client component 104 in one example wishes to view or interact with the music notation application. During a setup phase 304, the user employs the web browser 112 of the client component 104 to request (STEP 306) a web page (e.g., HTML page) that is provided by the server component 102. For example, the user enters a web address that that corresponds to the web page provided by the server component 102.

Upon receipt of the request for the application 107, the server component 102 in one example prepares to handle the application. For example, the server component 102 may execute the application, perform a function call, and/or read a configuration file to initialize one or more hardware components (e.g., memory, processors) and/or software components (e.g., data structures, objects, function libraries) for the application 107. The server component 102 generates (STEP 308) the local display grid 202 with the plurality of tiles and sub-divides the user interface image (e.g., a local tiled image). The server component 102 then sends (STEP 310) the local tiled image to the web browser 112 as a web page. The web page in one example comprises a plurality of DIV web page elements with absolute positioning. The DIV web page elements in one example comprise an image sub-portion from a tile in the local display grid 202. Accordingly, the server component 102 employs the DIV web page elements to provide a remote display of the user interface image within the display of the web browser 112, as will be appreciated by those skilled in the art.

The user of the client component 104 in one example wishes to interact with or modify the user interface of the music notation application. During an update phase 312, the web browser 112 receives (STEP 314) one or more user inputs from the user of the client component 104. Examples of user inputs comprise mouse clicks and/or movements, key presses of a keyboard, receiving an audio input from a microphone or electronically coupled musical instrument, distilled results of user input (such as a location of a click and id of a selected tool) and/or combinations thereof. The client component 104 in one example sends (STEP 316) the user input to the server component 102. In a further example, the client component 104 may optionally perform processing on or related to the user input. For example, the client component 104 and/or the web browser 112 may update a display of the web page based on the user input. The client component 104 in one example sends the user input to the server component 104 through employment of the XMLHttpRequest API.

Upon receipt of the user inputs from the client component 104, the server component 102 in one example processes the user input. For example, the server component 102 provides the user input to the application. In a further example, the server component 102 modifies a software component based on the user input, for example, to store the user inputs. The server component 102 in one example updates the user interface image based on the user input. The server component 102 determines which tiles have been modified or updated. The server component 102 then updates (STEP 320) the web page elements in the web browser 112 that correspond to the modified or updated tiles. For example, the server component 102 updates the sub-images of the corresponding DIV web page elements. The server component 102 in one example updates the sub-images through employment of the XMLHttpRequest API. As the user interacts with the user interface image, multiple instances of the update phase 312 may occur. In alternative examples, another source may cause an update to the user interface image. Examples of the source comprise the application itself, a hardware component of the server component 102, and/or a software component executed on or in communication with the server component 102.

In the implementation where the application comprises a musical notation application, the user in one example employs the graphical user interface to enter musical information (e.g., audio note placement information), for example, to place musical notes on a staff. The user in one example employs the web browser 112 for an audio feedback phase 322. The user employs the web browser 112 to request (STEP 324) audio feedback from the server component 102. The web browser 112 sends (STEP 326) the request to the server component 102. The server component 102 in one example generates (STEP 328) an audio output or track (e.g., encoded audio stream or file) based on the user inputs. For example, the audio output comprises an audio interpretation of the musical information entered by the user based on the information in a data structure, as described herein. The graphical user interface 402 in one example allows a user to select a “voice” for the audio output to emulate a desired instrument, for example, a piano, guitar, or saxophone.

The server component 104 sends (STEP 330) the audio output to the web browser 112. The web browser 112 in one example plays back the audio output through employment of the audio plug-in 118. The audio plug-in 118 in one example is configured to play back (STEP 332) the audio output to the user through the audio output device 116. Accordingly, the musical notation application in this implementation allows the user to write music using a web browser and then have the music played back through the web browser. As one advantage of this implementation, the user does not need to install a specialized music application, the application is provided through a commonly available web browser. In addition, the web page and the audio output are provided by the server component 102 and client component 104 through a same user interface, as will be appreciated by those skilled in the art.

Turning to FIG. 4, one example of a graphical user interface 402 comprises an area to receive a musical symbol and at least one musical symbol. In the implementation of FIG. 4, the graphical user interface 402 comprises staves 404 and 406. The at least one musical symbol in one example comprises treble clef 408 and bass clef 410 for the staves 404 and 406 (other examples might be comprised of a time signature or part of a time signature), respectively. As is known in the art, the clef indicates the pitch of notes written within the staff. In alternative implementations, a clef or even the staff may be omitted to simplify the user interface image, for example, for a beginner music student that has not yet learned the meanings of the musical symbols. In other implementations, the clef or the number of staves may be selectable by the user of the web browser 112, for example, to allow the creation of a full musical score or conductor's score. The graphical user interface 402 in a further example comprises one or more of buttons 414, 416, 418, and 420, key signature selector 422, tempo selector 424, and interaction selector 426. Many other tools for entering, manipulating, and/or modifying musical symbols may be possible, as will be appreciated by those skilled in the art.

The at least one musical symbol further comprises a plurality of musical symbols 412. One or more of the musical symbols may be referred to as “tools” that allow the user to interact with the graphical user interface 402. In the implementation shown, the plurality of musical symbols (tools) 412 comprise a whole note, half note, quarter note, eighth note, whole rest, half rest, quarter rest, eighth rest, dotted symbol, accidental sharp, accidental flat, accidental natural, and measure line. In alternative implementations, the plurality of musical symbols (tools) 412 may be reduced to simplify the interface for beginner music students or expanded to meet the demands of advanced music students. Alternative symbols may be used to indicate “upstrokes” and “downstrokes” (e.g., for instruments played with a bow or plectrum) or to indicate only rhythm instead of both rhythm and pitch values, for example, as a rhythm training exercise. Additional musical symbols, such as ties, slurs, accent marks, dynamic notations (e.g., piano, mezzo-forte, fortissimo), and others known to those skilled in the art may also be used. Additionally, non-standard symbols such as percussion, bell and other specific notations known to those skilled in the art may also be used. For example, each line may indicate one percussion instrument on a staff. Additional markings specific to a musical instrument may also be added.

Referring to FIG. 4, upon completion of the setup phase (STEP 304), the web browser 112 in one example displays the graphical user interface 402. The user of the musical notation application in one example employs a mouse (e.g., an instance of the user input device 114) to move a mouse cursor 428 and interact with the graphical user interface 402. The graphical user interface 402 in one example is configured to provide a drag-and-drop user interface. Other interfaces are also possible.

Turning to FIGS. 4-7, one example of a drag-and-drop placement of a musical note is shown. A quarter note 430 is dragged from the plurality of musical symbols 412 and dropped as an “F” note 704 on the staff 404 (i.e., the first space in the treble clef). The musical notation application in one implementation is configured to align musical symbols that are placed by the user to a pre-determined vertical orientation along the staves 404 and 406. In a first example, musical notes may be centered within a space or on a line. In a second example, rests may be centered within the staves or attached to a predetermined line within the staves.

In another implementation, the musical notation application is configured to modify the musical symbols and/or align the musical symbols horizontally. In a first example, the musical notation application may align and/or order the musical notes to be spaced horizontally based on their time value and/or position (e.g., x,y coordinates). In a further example, the musical notation application may add horizontal bars to join notes together, for example, two or more adjacent eighth notes or sixteenth notes. In a second example, the musical notation application may place an accidental symbol a predetermined distance in front of a musical note that it affects or a “dot” a predetermined distance behind a musical note. In a third example, the musical notation application combines two or more musical notes if the X positions of the two or more musical notes are within a predetermined distance, for example, notes that are within a chord. Other implementations of musical symbol alignment by the musical notation application will be apparent to those skilled in the art. The alignment implementations may be selectively employed based on a configuration file for the musical notation application or a user preference.

The server component 102 in one example comprises a software component (e.g., a data structure) for storage of user inputs related to musical information entered by the user of the web browser 112. The musical notation application in one example modifies the data structure based on the user input. For example, the data structure stores musical information related to musical notes selected by the user of the client component 104. The graphical user interface in one example is configured such that the musical symbols are located within an x-y coordinate system. The coordinate system may employ absolute or relative positioning for the musical symbols. The data structure in one example stores information such as x,y coordinates, a note value (e.g., frequency or pitch), a symbol type or note type (e.g., half note, quarter note, rest, accent, etc) and a relationship to any related musical symbols. Examples of related musical symbols comprise notes within a chord, “dots” (e.g., for a dotted note), and accidentals. The server component 102 in one example employs the data structure for generation of the audio output. For example, the server component 102 may determine a frequency of a note based on a Y position of the note, determine a duration of the note based on the note type, and determine an order of the note based on an X position of the note.

The buttons 414, 416, 418, and 420, key signature selector 422, tempo selector 424, interaction selector 426, and other user interaction items of the graphical user interface 402 may be implemented with any of a plurality of techniques. In a first example, HTML elements such as combo boxes, list boxes, and buttons are used. In a second example, the graphical user interface 402 is configured to determine coordinates of a mouse click or other input. In this example, the “button” exists on the server component 102 and an image of the button is presented to the user on the client component 104. The application determines if the coordinates are located within a button and triggers the button if appropriate.

The button 414 in one example comprises a “trash” button for removal of selected musical symbols from the graphical user interface 402. The graphical user interface 402 in one example is configured to allow the user to drag and drop one or more musical symbols onto the button 414 to remove them from the graphical user interface 402. The button 416 in one example comprises a “play” button. For example, the user selects the play button to request (STEP 324) the audio from the server component 102. The button 418 in one example comprises a “clear” button. For example, the user selects the clear button to request that the staves 404 and 406 be cleared and/or reset. The button 420 in one example comprises a “help” button that the user can select to open or request a help menu.

The key signature selector 422 in one example provides a drop-down box with a plurality of key signatures to the user of the client component 104. For example, the user may select a key signature for the staves 404 and 406 to indicate a number of sharps and/or flats. The tempo selector 424 in one example allows the user to enter a tempo for the musical notes to be played at.

The interaction selector 426 in one example provides alternate input styles for the user to provide inputs to the graphical user interface 402. In the implementation of FIG. 4, the interaction selector 426 provides a “drag and drop” style and a “click and sprinkle” style. The “drag and drop” style allows the user to drag one musical symbol at a time from the plurality of musical symbols 412 to the staves 404 or 406. Additional musical symbols are then dragged from the plurality of musical symbols 412. The “click and sprinkle” style allows the user to designate a selected musical symbol of the plurality of musical symbols 412. Once designated, the user may click one or more times on the staves 404 and/or 406 to place one or more instances of the selected musical symbol. Alternative input styles will be apparent to those skilled in the art, for example, using a computer keyboard with keys mapped to musical symbols or using a musical keyboard.

Numerous alternative implementations and applications of the present invention exist. The musical notation application may be configured to save and/or load the inputs from a user, for example, as a musical score. The musical score may be stored in a database, XML file, MIDI file, or other formats.

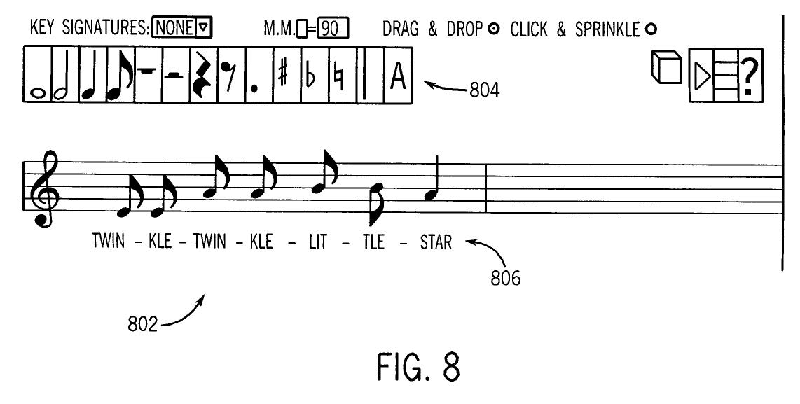

Turning to FIG. 8, a graphical user interface 802 in one implementation may be modified to allow the user to enter in lyrics or comments. For example, the user interface 402 may comprise a lyric tool 804 for placing lyrics 806 underneath a staff with corresponding notes. The musical notation application may employ a standard keyboard, a speech recognition plugin or software module, or other text entry methods to obtain the text for the lyrics. The musical notation application in one example allows for syllables of the lyrics to be synchronized and/or coupled to the musical notes either automatically or as designated by the user, for example, where the notes correspond to the duration and pitch of the syllables.

While one implementation for entering musical symbols is described herein, many alternatives exist for providing a teaching tool for music. In one example, the musical notation application provides a plurality of roles for users to “log in” to the application as a teacher or student. Accordingly, the user interface features offered to the different user roles may be different. For example, the graphical user interface 402 for a teacher may be modified to allow the creation of a fill-in-the-blank, dictation, ear training, and/or rhythm assignments for a student or a class of students. The graphical user interface 402 for a student may be modified to allow the student to submit a completed assignment for grading. The musical notation application may be configured to automatically grade the assignment or the teacher may manually review the submitted assignment. The graphical user interface 402 in one example is configured to support the Kodály method of music education and may support appropriate rhythm syllables and/or simplified rhythmic symbols (e.g., musical notes without note heads), as will be appreciated by those skilled in the art.

In one implementation, the musical notation application is configured to provide a sight-reading exercise to a student. The musical notation application loads a score for the student. The score may be selected by the student, a teacher, or automatically by the musical notation application (e.g., based on previous exercises/scores attempted by the student, evaluations of the student's ability, accuracy, etc.). The musical notation application in one example is configured to scroll musical notes across the graphical user interface 402 for the student to sight-read. The musical notation application may scroll the notes horizontally across a staff, scroll a staff vertically, or scroll the web page up or down to reveal/hide the desired notes. In a further example, the musical notation application may receive user inputs from the client component 104 that comprise the notes played by the user, for example, MIDI signals or an audio signal from a microphone. The musical notation application in one example records the user inputs. The user inputs may be reviewed by a teacher (or the musical notation application) at a later time for grading or evaluation. In another example, the musical notation application evaluates the user inputs in real-time.

The musical notation application in one implementation may adjust the musical scores provided to the student. In a first example, the musical notation application provides different musical scores as a student progresses. For example, the musical notation application may provide an additional assignment in a sequence of assignments (e.g., designated by a teacher) to the student upon the completion of a previous assignment. As a second example, the musical notation application may dynamically determine what musical scores are appropriate for the student. For example, a student that is entering user inputs (e.g., through sight-reading, entering notes, rhythms, etc) accurately and/or consistently may be provided with more challenging assignments. In another implementation, the musical notation application, the graphical user interface 402, and/or the web browser 112 may provide visual and/or audio feedback to the student as they work on the assignment, for example, indicating a correct or incorrect entry for each input from the user or at the end of a completed assignment. In yet another example, the musical notation application and the graphical user interface 402 may be configured to disallow incorrect inputs from the student, for example, to force the correct metering of a musical passage. The musical notation application in one example compares the data structure with the musical information entered by the user with a benchmark data structure to determine the accuracy of the user inputs. In another example, the musical notation application compares the audio output with a benchmark audio track to determine the accuracy of the user inputs.

The musical notation application in another implementation is configured to receive an input from the user of the client component 104 and generate a score that represents the input. In a first example, the application receives an uploaded data file from the user through the web browser 112. The uploaded data file in one example comprises a scanned sheet of music, such as an image file, Adobe Acrobat file (Adobe Systems Inc., San Jose, Calif.), or other data type. In one example, the musical notation application provides a blank template (e.g., a blank staff) for the user to print out and write in musical notes, then scan in the template. In a second example, the uploaded data file is an audio file. For example, the user may record a musical instrument or vocal track as an MP3, WAV, or other audio format. In a third example, the input is recorded by the client component 104 and streamed to the server component 102, as will be appreciated by those skilled in the art. The musical notation application is configured to convert the input into a score, for example, using music recognition software. Examples of music recognition software comprise IntelliScore (Innovative Music Systems, Inc.; Coconut Creek, Fla.), WIDI Recognition System or WIDI Audio to MIDI plugin (Widisoft; Moscow, Russia).

The server component 102 in one implementation updates the graphical user interface 402 based on an input from outside of the application 107 or the client component 104. In one example, the server component 102 comprises an operating system that provides the input. In another example, another application running on or in communication with the server component 102 provides the input. Examples of inputs comprise pop-up windows, notifications, and others, as will be appreciated by those skilled in the art.

The server component 102 in one implementation adjusts a size of the local display grid 202. The application 107 may increase one or more dimensions of the local display grid to provide the user with a larger graphical user interface 402. For example, the application 107 and/or the server component 102 may initialize a local display grid of a first size and then increase the size of the local display grid to a second size (or dynamically adjust the size) as needed or requested by the user of the client component 104. Accordingly, the application 107 creates new tiles to fill the local display grid 202 as its size is increased. The server component 102 in one example sends new sub-images as new web page elements to the client component 104 to provide the larger graphical user interface 402.

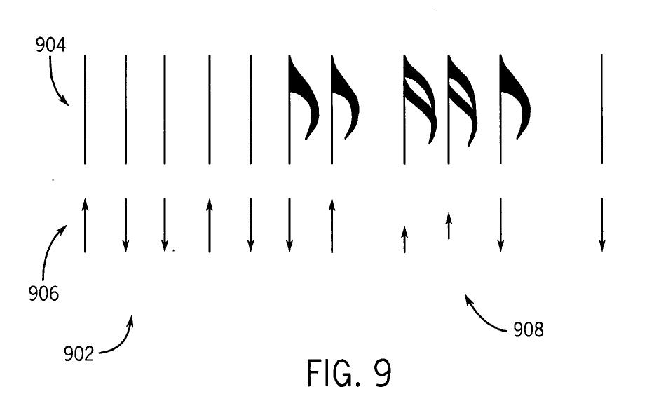

Turning to FIG. 9, a graphical user interface 902 in one implementation is simplified by omitting the staff and key signature. The graphical user interface 902 in this implementation comprises rhythm symbols 904 and directional arrows 906. The rhythm symbols 904 do not comprise note heads in this implementation. The directional arrows 906 in one example provide an indication of “upstrokes” and/or “downstrokes”. In another example, directional arrows 908 may indicate where the beginning and end of a beat are located.

The apparatus 100 in one example comprises a plurality of components such as one or more of electronic components, hardware components, and computer software components. A number of such components can be combined or divided in the apparatus 100. An example component of the apparatus 100 employs and/or comprises a set and/or series of computer instructions written in or implemented with any of a number of programming languages, as will be appreciated by those skilled in the art.

The apparatus 100 in one example employs one or more computer-readable signal-bearing media. The computer-readable signal-bearing media store software, firmware and/or assembly language for performing one or more portions of one or more implementations of the invention. Examples of a computer-readable signal-bearing medium for the apparatus 100 comprise the recordable data storage medium 108 of the server component 102 and client component 104. The computer-readable signal-bearing medium for the apparatus 100 in one example comprise one or more of a magnetic, electrical, optical, biological, and atomic data storage medium. For example, the computer-readable signal-bearing medium comprise floppy disks, magnetic tapes, CD-ROMs, DVD-ROMs, hard disk drives, and electronic memory.

The steps or operations described herein are just for example. There may be many variations to these steps or operations without departing from the spirit of the invention. For instance, the steps may be performed in a differing order, or steps may be added, deleted, or modified.

Although example implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

What is claimed is:

1. A method, comprising the steps of:
partitioning a user interface image for an application into a plurality of sub-images that correspond to a plurality of tiles of a local display grid; and
sending at least one sub-image of the plurality of sub-images to a client component as at least one web page element with an absolute position for a remote display of the user interface image by a web browser of the client component, wherein the at least one web page element corresponds to at least one tile of the plurality of tiles of the local display grid.

2. The method of claim 1, further comprising the steps of:
modifying the user interface image within the local display grid;
identifying at least one modified tile of the local display grid; and
sending to the client component at least one modified sub-image that corresponds to the at least one modified tile to cause an update of the web page element that corresponds to the at least one modified tile by the web browser.

3. The method of claim 2, wherein the step of sending to the client component the at least one modified sub-image that corresponds to the at least one modified tile to cause the update of the web page element that corresponds to the at least one modified tile by the web browser comprises the step of:
dynamically sending the at least one modified sub-image as the at least one web page element through employment of an asynchronous JavaScript and XML (AJAX) framework.

4. The method of claim 2, wherein the step of identifying the at least one modified tile of the local display grid comprises the step of:
identifying the at least one modified tile through employment of a hash table that translates coordinates of changes to the user interface image to an index of the at least one modified tile.

5. The method of claim 2, wherein the step of modifying the user interface image within the local display grid comprises the step of:
modifying the user interface image based on a user interface change in the application.

6. The method of claim 5, wherein the step of modifying the user interface image based on the user interface change in the application comprises the steps of:
receiving a user input from the web browser of the client component that is based on a user interaction with the web browser of the client component; and
modifying the user interface image based on the user input.

7. The method of claim 5, wherein the application comprises a first application, wherein the step of modifying the user interface image based on the user interface change in the application comprises the step of:
receiving an input from a second application that causes the change in the user interface image.

8. The method of claim 1, further comprising the steps of:
adjusting at least one dimension of the local display grid from a first size to a second size;
adjusting the at least one web page element of the remote display to correspond with the second size of the local display grid.

9. The method of claim 8, wherein the step of adjusting the at least one web page element of the remote display to correspond with the second size of the local display grid comprises at least one of:
sending a new sub-image as a new web page element with an absolute position for the remote display to adjust the remote display based on the second size of the local display grid if the second size of the at least one dimension is larger than the first size of the at least one dimension.

10. The method of claim 1, wherein the step of sending the at least one sub-image of the plurality of sub-images to the client component as the at least one web page element with the absolute position comprises the step of:
sending the at least one sub-image to the client component as at least one division hypertext markup language (HTML) tag.

11. The method of claim 1, further comprising the steps of:
receiving a request for the application from the web browser of the client component;
generating the local display grid, wherein the local display grid comprises the plurality of tiles;
executing the application;
generating the user interface image for the application.

12. A method, comprising the steps of:
generating a user interface image for a music composition application requested by a user of a web client;
sending the user interface image to the web client;
establishing an asynchronous hypertext transfer protocol (HTTP) connection with the web client;
receiving a user input from the web client through the asynchronous HTTP connection;
updating the user interface image based on the user input; and
sending an updated portion of the user interface image to the web client through the asynchronous HTTP connection.

13. The method of claim 12, wherein the step of sending the updated portion of the user interface image to the web client through the asynchronous HTTP connection comprises the step of:
sending the updated portion of the user interface image as a tiled image portion within a web page element with absolute positioning.

14. The method of claim 12, wherein the step of receiving the user input from the web client through the asynchronous HTTP connection comprises the steps of:
receiving musical note information from the web client;
generating an audio output based on the musical note information;
sending the audio output to the web client.

15. The method of claim 14, wherein the musical note information comprises an X location, a Y location, and a note type for at least one musical note, wherein the step of generating the audio output based on the musical note information comprises the steps of:
ordering the at least one musical note based on the X position of the at least one musical note;
determining a frequency of the at least one musical note based on the Y position of the at least one musical note;
determining a duration of the at least one musical note based on the note type.

16. The method of claim 15, wherein the at least one musical note comprises a plurality of musical notes, wherein the step of ordering the at least one musical note based on the X position of the at least one musical note comprises the step of:
combining two or more musical notes of the plurality of musical notes if the X positions of the two or more musical notes are within a predetermined distance.

17. An apparatus, comprising:
a server component that comprises an audio processor;
wherein the server component is configured to provide a web page to a client component and to receive audio note placement information from the client component;
wherein the server component is configured to employ the audio processor to convert the audio note placement information into an audio track.

18. The apparatus of claim 17, wherein the server component is configured to provide the audio track to the client component through the web page;
wherein the server component is configured to provide the web page and the audio track through a same user interface to the client component.

19. The apparatus of claim 17, wherein the server component is configured to compare the audio note placement information with a benchmark to check for accuracy.

20. The apparatus of claim 17, wherein the audio note placement information comprises an X position, a Y position, and a note type for a plurality of musical symbols.
